(19) United States
(12) Patent Application Publication
(10) Pub. No.: US 2009/0247676 A1
(43) Pub. Date: Oct. 1, 2009

(54) Water-Based Flame-Stabilizing Dispersions

(75) Inventors: Olaf Mueller, Königstein (DE); Albert Muenkel, Liederbach (DE); Bjoern Fechner, Eppstein (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT INTERNATIONAL LTD., 4132 Muttenz (CH)

(21) Appl. No.: 12/298,357

(22) PCT Filed: Mar. 27, 2007
(86) PCT No.: PCT/EP07/02679

§ 371 Date: Oct. 24, 2008

(30) Foreign Application Priority Data
Apr. 26, 2006 (DE) 102006019509.4
Mar. 27, 2007 (EP) PCT/EP2007/002679

(51) Int. Cl. C08K 5/51

(52) U.S. Cl. 524/119

(57) ABSTRACT

The invention is a watery dispersion containing
a) a flame-stabilizing substance of general formula (I)

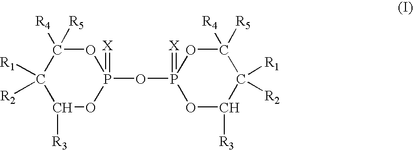

where R₁ is hydrogen, C₁₋₄-alkyl, —CH₂Cl, —CH₂Br, —CH₂O—C₁₋₄-alkyl or phenyl, R₂ is hydrogen, C₁₋₄-alkyl, —CH₂Cl, —CH₂Br or —CH₂O—C₁₋₄-alkyl, or R₁ and R₂ together with the ring carbon atoms form cyclohexylidene, cyclohexenylidene or 3,4-dibromocyclohexylidene, R₃ and R₅ independent of each other are hydrogen or C₁₋₄-alkyl, R₄ is hydrogen or methyl, and X is oxygen or sulfur, and b) a dispersive agent or combination of dispersive agents.

The present invention provides waterborne formulations of dioxaphosphorinane flame retardants, processes for their production, their use for conferring flame retardancy on natural, cellulosic and synthetic fibrous materials.

To achieve a satisfactory level of flame retardancy on viscose fibers, the flame retardants used have to meet high requirements, in particular with regard to purity, particle fineness, storage stability, recrystallization resistance, viscosity, surface tension and conductivity. Particle fineness and stability requirements in particular are very high in order that the operation of spinning fine to ultrafine denier viscose fibers of high value does not give rise to fiber and filament breakages, linear density fluctuations, fluctuations in fiber fineness, strength losses or to die blockages, which are the cause of inferior quality for the end product.

Prior art flame retardant formulations as described in DE-41 28 638 A1 for example often no longer meet the requirements of the viscose industry, since they have deficiencies in fine division and thermal and storage stability, in particular with regard to recrystallization resistance, or do not meet present-day requirements in terms of ecology.

It is an object of the present invention to provide flame retardant formulations that meet the aforementioned requirements with regard to fine division, thermal and storage stability, recrystallization resistance, very good spinnability without significant reduction in fiber strengths and filter lives, and also present-day ecological requirements expected of the dispersant.

We have found that this object is achieved, surprisingly, by a combination from a specific group of flame retardants and dispersants.

The present invention accordingly provides an aqueous dispersion containing

a) a flame retardant of the general formula (I)

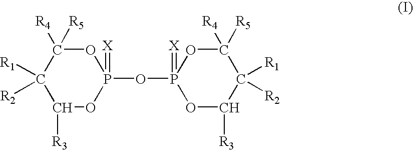

where
R₁ is hydrogen, C₁₋₄-alkyl, —CH₂Cl, —CH₂Br, —CH₂O—C₁₋₄-alkyl or phenyl,
R₂ is hydrogen, C₁₋₄-alkyl, —CH₂Cl, —CH₂Br or —CH₂O—C₁₋₄-alkyl, or
R₁ and R₂ combine with the connecting ring carbon atom to form cyclohexylidene, cyclohexenylidene or 3,4-dibromocyclohexylidene,
R₃ and R₅ are independently hydrogen or C₁₋₄-alkyl,
R₄ is hydrogen or methyl, and
X is oxygen or sulfur,
b) a dispersant from the group of the castor oil alkoxyl esters, ricinoleic acid alkoxyl esters, of the nonionic oligo- or polyesters of aromatic dicarboxylic acids, C₂-C₈-alkylenediols and poly(C₁-C₄-alkylene) glycols and/or methylpoly(C₂-C₄-alkylene) glycols, or of a combination of these nonionic oligo- or polyesters with dialkyl sulfosuccinates
   and
c) if appropriate a retention agent.

Flame retardants of the general formula (I) are known per se from DE 41 28 638 A1.

Preference is given to those flame retardants of the formula (I) wherein the R₁ radicals are methyl, ethyl, propyl, chloromethyl, bromomethyl or phenyl.

Preference is further given to those flame retardants of the formula (I) wherein the R₂ radicals are methyl, ethyl, propyl, chloromethyl or bromomethyl.

Particular preference is given to flame retardants of the formula (Ia)

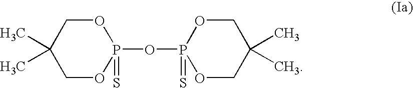

Dispersants from the group of the castor oil alkoxyl esters and ricinoleic acid alkoxyl esters are known from EP-B1-0 582 928.

The castor oil underlying the castor oil alkoxyl ester is preferably commercially available castor oil, consisting essentially of a glyceride of ricinoleic acid, oleic acid, linoleic acid and stearic acid. It contains free hydroxyl groups and olefinic double bonds.

Ricinoleic acid contains one olefinic double bond and one free alcoholic OH group.

Castor oil alkoxyl esters and ricinoleic acid alkoxyl esters are usually esterified and/or etherified with 1 to 100 and preferably 5 to 50 alkoxy radicals. Alkoxy refers preferably to ethoxy, 1,2-propoxy, 2,3-propoxy or a combination thereof. Both castor oil alkoxyl ester and ricinoleic acid alkoxyl ester can be esterified with further acid radicals from the group of the resin acids, C₂-C₁₂-dicarboxylic acids, C₂-C₁₂-sulfodicarboxylic acids or fatty acids. Resin acids are for example abietic acids and also commercially available rosin varieties. C₂-C₁₂-Dicarboxylic acids and C₂-C₁₂-sulfodicarboxylic acids are for example maleic acid and sulfosuccinic acid.

Dispersants from the group of the nonionic oligo- or polyesters are obtainable by polycondensation of dicarboxylic acid and glycol components comprising
(I) one or more aromatic dicarboxylic acids, esters or anhydrides;
(II) C₂-C₈-alkylenediols;
(III) poly(C₁-C₄-alkylene) glycols and/or methylpoly(C₂-C₄-alkylene) glycols;
(IV) if appropriate water-soluble addition products of alkylene oxide onto C₁-C₂₄-alcohols, onto C₆-C₁₈-alkylphenols or onto C₈-C₂₄-alkylamines; and
(V) if appropriate one or more polyols.

Preferred dispersants from the group of the nonionic oligo- or polyesters are obtainable by polycondensation of
(I) 10% to 50% by weight and in particular 15% to 30% by weight of one or more aromatic dicarboxylic acids, esters or anhydrides;
(II) 2% to 50% by weight and in particular 5% to 45% by weight of C₂-C₈-alkylenediols;
(III) 3% to 80% by weight and in particular 5% to 75% by weight of poly(C₁-C₄-alkylene) glycols and/or methylpoly(C₂-C₄-alkylene) glycols;
(IV) 0% to 10% by weight of a water-soluble addition product of alkylene oxide onto C₁-C₂₄-alcohols, onto C₆-C₁₈-alkylphenols or onto C₈-C₂₄-alkylamines and
(V) 0% to 10% by weight of one or more polyols,
   all based on the total weight of the oligo- or polyester.

Preferred nonionic oligo- or polyesters conform to the formula (2),

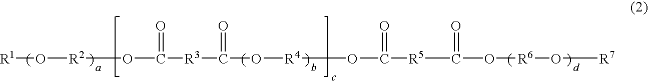

where
R¹ and R⁷ are a linear or branched C₁-C₁₈-alkyl radical,
R², R⁴, R⁶ are independently (C₁-C₈)-alkylene,
R³ and R⁵ are arylene or alkarylene,
a, b and d is a number between 1 and 200 subject to the proviso that the sum total of a, b and d is at least 5,
c is a number between 1 and 20.

Particular preference is given to dispersants of the formula (2) wherein
R¹ and R⁷ are methyl and/or ethyl,
R², R⁴, R⁶ are ethylene, 1,2-propylene, 2,3-propylene or mixtures thereof,
R³ and R⁵ are 1,4-phenylene and 1,3-phenylene,
a, b and d are a number between 1 and 100 subject to the proviso that the sum total of a, b and d is at least 5;
c is a number between 1 and 10.

Dialkyl sulfosuccinates are for example sodium 2-diethylhexylsulfosuccinate, sodium 2-dioctylsulfosuccinate and potassium 2-didodecylsulfosuccinate.

The dispersions of the present invention advantageously contain 5% to 50% by weight of a flame retardant according to (a); 0.3% to 20% by weight of dispersant according to (b) if appropriate in combination with 0.01% to 5% by weight of a dialkyl sulfosuccinate, 0% to 15% by weight of retention agent according to (c), balance water, all based on the total weight of the dispersion.

Preferred dispersions contain
a) 5% to 50% and preferably 10% to 45% by weight of flame retardant of the formula (I),
b1) 1% to 15% and preferably 3% to 10% by weight of a dispersant from the group of the castor oil alkoxyl esters and ricinoleic acid alkoxyl esters, or
b2) 1% to 15% and preferably 4% to 13% by weight of a dispersant from the group of the nonionic oligo- or polyesters of aromatic dicarboxylic acids, C₂-C₈-alkylenediols and poly(C₁-C₄-alkylene) glycols and/or methylpoly(C₂-C₄-alkylene) glycols, if appropriate in combination with 0.05% to 3% by weight of a dialkyl sulfosuccinate,
c) 0% to 15% and preferably 2% to 10% by weight of a retention agent,
d) 5% to 80% and preferably 10% to 60% by weight of water,
e) 0% to 10% and preferably 0.5% to 10% by weight of further customary additives,
   all based on the total weight of the dispersion.

Retention agents are used as water retention agents to improve the resistance to drying out (crusting) and freezing. Retention agents here are comparatively high-boiling solvents such as polyhydric alcohols, polyols, glycol ethers, acid amides or sugar derivatives, examples being ethylene glycol, diethylene glycol, triethylene glycol, low molecular weight polyethylene glycols and/or their ethers, propylene glycols, dipropylene glycols, low molecular weight propylene glycols and/or their ethers, butylene glycols, hexylene glycols, glycerol, diglycerol, pentaerythritol or formamide.

Further customary additives are for example defoamers, preservatives, cationic, anionic or nonionic surface-active substances (surfactants and wetting agents), and also agents for regulating the viscosity, for example polyvinyl alcohol, cellulose derivatives, or water-soluble natural or artificial resins as film formers or binders to enhance the bonding strength and ruboff resistance, and also amines, for example ethanolamine, diethanolamine, triethanolamine, N,N-dimethylethanolamine or diisopropylamine, or aqueous sodium hydroxide solution, which mainly serve to raise the pH of the flame retardant formulation.

The present invention further provides a process for producing the dispersions of the present invention, which comprises finely dispersing the flame retardant together with the dispersant in water by means of a dispersing assembly, preferably a stirred ball mill operated at a stirrer tip speed of above 12 m/s in particular, and under the action of nonmetallic grinding media not more than 1 mm in diameter. The remaining additives can be present during the operation of fine dispersion and/or be added later.

It is also possible to use an ordinary stirred ball mill, in which case however a coarser particle size distribution and a longer processing time have to be accepted.

The present invention also provides for the use of the dispersion of the present invention for bulk flame retardant finishing or surface treatment of cellulosic materials, such as staple fibers, filaments, monofils, non wovens, sausage casings, cellophane, combinations of cellulosic and/or animal, vegetable and/or synthetic fibers, and also vegetable, animal or synthetic fibers, in particular for finishing regenerated cellulose and cellulose acetate.

The regenerated cellulose, in particular xanthate, is mixed in dissolved form, for example prior to spinning, with the dispersion of the present invention. The mixing ratio is generally between 10 and 40 parts of the dispersion of the present invention per 100 parts of pure regenerated cellulose.

The dispersions of the present invention can also be used in combination with pigments, pigment formulations and/or dyes. Addition is effected as described above for spin or solvent dyeing with simultaneous bulk flame retardant finishing or surface treatment of cellulosic materials, such as stable fibers, filaments, monofils, non wovens, sausage casings, cellophane, sponge cloths (mixtures or combinations of cellulosic and/or animal, vegetable and/or synthetic fibers), and also vegetable, animal or synthetic fibers.

The formulations of the present invention are further useful for surface coating or for bulk flame retardant finishing alone or in combination with colorants, such as pigments, pigment formulations and/or dyes, for shoe polish, candles, crayons, playdough, cosmetics, painting and dispersion colors, emulsion paints, printing colors or inks, for example textile printing colors, flexographic printing inks or gravure printing inks, for wallpapers and wallpaper colors or inks, for wood preservation systems, for lacquers, for seed, for glass bottles, for mass coloration of roof tiles, for plasters, for wood stains, for paper stocks, for colored pencil leads, felt tip pens, artists' inks, liquid inks, pastes for ballpoint pens, chalks, washing and cleaning compositions, shoe care products, latex products, abrasives and also of plastics and macromolecular materials, and also as flame retardants in electrophotographic toners and developers, for example one- or two-component powder toners, magnetic toners, liquid toners, polymerization toners and also further specialty toners, as flame retardants in ink jet inks.

The formulations of the present invention are further useful for surface coating or for bulk flame retardant finishing of articles composed for example of metal, wood, plastic, glass, ceramic, concrete, textile material, paper or rubber.

Useful colorants include organic and inorganic pigments and also polymer-soluble, partly polymer-soluble or polymer-insoluble dyes. Useful organic pigments include monoazo, disazo, laked azo, β-naphthol, naphthol AS, benzimidazolone, disazo condensation, azo metal complex pigments and polycyclic pigments such as for example phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

Useful inorganic pigments include for example titanium dioxides, zinc sulfides, iron oxides, chromium oxides, ultramarine, nickel or chromium antimony titanium oxides, cobalt oxides, mixed oxides of cobalt and of aluminum, bismuth vanadates and also cut pigments.

Useful organic dyes include acid dyes, direct dyes, sulfur dyes and their leucoform, metal complex dyes, vat dyes, basic dyes or reactive dyes.

### EXAMPLES

The examples hereinbelow utilize dispersants which are characterized as follows:

D1: dispersant from the group of the castor oil ethoxyl esters according to Preparation Example 16 a) of EP-B-0 582 928, 50% solution in water.
D2: oligo- and polyesters of the formula (2).
D3: sodium 2-diethylhexylsulfosuccinate.

### Example 1

45 parts of flame retardant of the formula (Ia),
14 parts of D1,
0.8 part of preservative,
and 40.2 parts of water are homogenized using a dissolver.

Subsequently, the suspension is ground with a stirred ball mill (of the type Getzmann Dispermat) with glass grinding media, ˜1 mm in diameter.

The flame retardant dispersion obtained can be adjusted with water to lower active content.

The flame retardant dispersion has a low viscosity, is foam free, sedimentation resistant and exhibits minimal tendency to form serum, if any. It is viscosity stable, with a very good recrystallization resistance in the course of storage at room temperature for several months.

### Example 2

A formulation containing

40 parts of flame retardant of the formula (Ia),
12 parts of D1,
5.0 parts of alpha-methyl-omega-hydroxy-polyethylene glycol ether retention agent,
0.8 part of preservative,
42.2 parts of water
is produced as described in Example 1.

### Example 3

A formulation containing

45 parts of flame retardant of the formula (Ia);
9.5 parts of D2 where R¹ and R⁷=methyl, R² and R⁶=ethylene, R³ and R⁵=1,4-phenylene, R⁴=1,2-propylene, a, b and d is in sum total about 35 on average, c is about 2 on average;
0.5 part of D3;
0.8 part of preservative;
44.2 parts of water
is produced as described in Example 1.

### Example 4

A formulation containing

45 parts of flame retardant of the formula (Ia),
12 parts of dispersant from the group of the castor oil ethoxyl esters according to Preparation Example 8 a) of EP-B-0 582 928, 50% solution in water,
0.8 part of preservative,
and 42.2 parts of water is produced as described in Example 1.

### Example 5

A formulation containing

45 parts of flame retardant of the formula (Ia),
12 parts of dispersant from the group of the castor oil ethoxyl esters according to Preparation Example 1b) of EP-B-0 582 928, 50% solution in water,
0.8 part of preservative, and
42.2 parts of water is produced as described in Example 1.

### Example 6

A formulation containing

45 parts of flame retardant of the formula (Ia),
14 parts of dispersant from the group of the castor oil ethoxyl esters according to Preparation Example 5b) of EP-B-0 582 928, 50% solution in water,
0.8 part of preservative, and
40.2 parts of water is produced as described in Example 1.

### Application Examples

A dispersion produced according to any one of Examples 1 to 6 is mixed 1:1 with demineralized water by stirring. 8 parts of this mixture are stirred into 100 parts of a cellulose xanthate solution (α-cellulose content 8%) and spun through dies into an aqueous coagulation bath containing, per liter, 125 g of H₂SO₄, 240 g of Na₂SO₄ (anhydrous) and 12 g of ZnSO₄ (anhydrous). The filament thus obtained is thoroughly washed, dried and processed into a knit fabric. This knit fabric is subjected to a flammability test (method of Fenimorc and Martin, Modern Plastics, November 1966, or LOI value determination, ASTM D2863). The untreated cellulose knit has an LOI value of about 18 for comparison, whereas the knit which has been treated according to the present invention has an LOI value between 25 and 30.

1) An aqueous dispersion comprising
a) a flame retardant of the general formula (I) 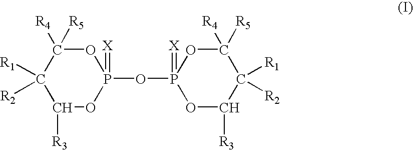
wherein
R₁ is hydrogen, C₁₋₄-alkyl, —CH₂Cl, —CH₂Br, —CH₂O—C₁₋₄-alkyl or phenyl,
R₂ is hydrogen, C₁₋₄-alkyl, —CH₂Cl, —CH₂Br or —CH₂O—C₁₋₄-alkyl, or
R₁ and R₂ combine with the connecting ring carbon atom to form cyclohexylidene, cyclohexenylidene or 3,4-dibromocyclohexylidene,
R₃ and R₅ are independently hydrogen or C₁₋₄-alkyl,
R₄ is hydrogen or methyl, and
X is oxygen or sulfur,
b) at least one dispersant selected from the group consisting of the castor oil alkoxyl esters, ricinoleic acid alkoxyl esters, nonionic oligo- or polyesters of aromatic dicarboxylic acids, C₂-C₈-alkylenediols. poly(C₁-C₄-alkylene) glycols, methylpoly(C₂-C₄-alkylene) glycols, and a combination of the nonionic oligo- or polyesters with dialkyl sulfosuccinates
and
c) optionally, a retention agent.

2) The dispersion according to claim 1 wherein the R₁ radicals are methyl, ethyl, propyl, chloromethyl, bromomethyl or phenyl.

3) The dispersion according to claim 1, wherein the R₂ radicals are methyl, ethyl, propyl, chloromethyl or bromomethyl.

4) The dispersion according to claim 1, wherein the flame retardant is of the formula (Ia)

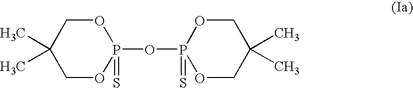

5) The dispersion according to claim 1, wherein the at least one dispersant is a castor oil alkoxyl ester or ricinoleic acid alkoxyl ester containing 1 to 100 alkoxy radicals, wherein the alkoxy radicals are selected from the group consisting of ethoxy, 1,2-propoxy and 2,3-propoxy.

6) The dispersion according to claim 5, wherein the castor oil alkoxyl ester or ricinoleic acid alkoxyl ester is esterified with an acid radical selected from the group consisting of resin acids, C₂-C₁₂-dicarboxylic acids, C₂-C₁₂-sulfodicarboxylic acids and fatty acids.

7) The dispersion according to claim 1, wherein the at least one dispersant from the group of the nonionic oligo- or polyesters is obtained by polycondensation of dicarboxylic acid and glycol components comprising one or more aromatic dicarboxylic acids, esters or anhydrides; C₂-C₈-alkylenediols; poly(C₁-C₄-alkylene) glycols, methylpoly(C₂-C₄-alkylene) glycols; and, optionally, water-soluble addition products of alkylene oxide onto C₁-C₂₄-alcohols, onto C₆-C₁₈-alkylphenols or onto C₈-C₂₄-alkylamines; and optionally, one or more polyols.

8) The dispersion according to claim 1, wherein the at least one dispersant is one or more compounds of the formula (2) 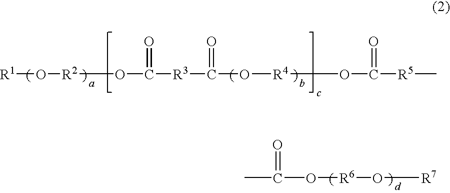
where
R¹ and R⁷ are a linear or branched C₁-C₁₈-alkyl radical,
R², R⁴, R⁶ are independently (C₁-C₈)-alkylene,
R³ and R⁵ are arylene or alkarylene,
a, b and d is a number between 1 and 200 subject to the proviso that the sum total of a, b and d is at least 5,
c is a number between 1 and 20.

9) The dispersion according to claim 8 wherein
R¹ and R⁷ are independently methyl or ethyl,
R², R⁴, R⁶ are ethylene, 1,2-propylene, 2,3-propylene or mixtures thereof,
R³ and R⁵ are 1,4-phenylene or 1,3-phenylene,
a, b and d are a number between 1 and 100 subject to the proviso that the sum total of a, b and d is at least 5;
c is a number between 1 and 10.

10) The dispersion according to claim 1, comprising 5% to 50% by weight of the flame retardant according to (a); 0.3% to 20% by weight of at least one dispersant according to (b) and optionally, with 0.01% to 5% by weight of a dialkyl sulfosuccinate, 0% to 15% by weight of retention agent according to (c), with the weight balance water, all based on the total weight of the dispersion.

11) The dispersion according to claim 1, comprising
a) 5% to 50% by weight of the flame retardant of the formula (I),
b1) 1% to 15% by weight of the at least one dispersant selected from the group consisting of the castor oil alkoxyl esters and ricinoleic acid alkoxyl esters, or
b2) 1% to 15% by weight of the at least one dispersant selected from the group of the nonionic oligo- or polyesters of aromatic dicarboxylic acids, C₂-C₈-alkylenediols, poly(C₁-C₄-alkylene) glycols and methylpoly(C₂-C₄-alkylene) glycols, and, optionally, in combination with 0.05% to 3% by weight of a dialkyl sulfosuccinate,
c) 0% to 15% by weight of a retention agent,
d) 5% to 80% by weight of water,
e) 0% to 10% by weight of additives,
all based on the total weight of the dispersion.

12) A process for producing a dispersion according to claim 1, comprising the steps of finely dispersing the flame retardant (a) together with the dispersant (b) and optionally, the components (c), (e) and (f) in water in a dispersing assembly.

13) A bulk flame retardant finishing or surface treatment of cellulosic material comprising a dispersion as claimed in claim 1.

14) A finishing agent for regenerated cellulose or cellulose acetate comprising a dispersion as claimed in claim 1.

15) The bulk flame retardant finishing or surface treatment for cellulosic materials as claimed in claim 13, wherein the cellulosic material is selected from the group consisting of staple fibers, filaments, monofils and non wovens.

16) A bulk flame retardant finishing or surface treatment of sausage casings, cellophane, combinations of cellulosic, animal, vegetable, synthetic fibers, or a combination thereof comprising a dispersion as claimed in claim 1.
